(19) United States
(12) Patent Application Publication
(10) Pub. No.: US 2016/0026280 A1
(43) Pub. Date: Jan. 28, 2016

(54) SHADELESS TOUCH HAND-HELD ELECTRONIC DEVICE AND TOUCH COVER

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/707,631

(22) Filed: May 8, 2015

(30) Foreign Application Priority Data
Jul. 25, 2014 (CN) 201410361461.1

(51) Int. Cl. G06F 3/041; G06F 3/0488

(52) U.S. Cl. CPC G06F 3/041; G06F 3/0488

(57) ABSTRACT

A shadeless touch hand-held electronic device comprises a panel, a memory unit, a touch cover and a control unit. The touch cover comprises a cover and a touch sensing structure. The cover is disposed on the side of the hand-held electronic device opposite to the panel, at least a part of the area of the touch sensing structure is disposed on the cover, and the touch sensing structure comprises a plurality of detection points to provide an input position. The control unit is electrically connected with the touch sensing structure and the memory unit. The area of the touch sensing structure and the area of the panel have a ratio relationship, the control unit converts the input position into a display position of the panel according to the ratio relationship, and the panel displays a visible sign at the display position.

### CROSS REFERENCE TO RELATED APPLICATIONS

This Non-provisional application claims priority under 35 U.S.C. §119(a) on Patent Application No(s). 201410361461.1 filed in People's Republic of China on Jul. 25, 2014, the entire contents of which are hereby incorporated by reference.

### BACKGROUND OF THE INVENTION

1. Field of Invention

This invention relates to a hand-held electronic device and, in particular, to a shadeless touch hand-held electronic device and a touch cover.

2. Related Art

With the progress of technologies, various novel information devices with the communication function are invented, such as cell phones, tablet computers, ultrabooks and GPS (Global Positioning System) navigation devices. Generally, a keyboard and mouse are commonly used to manipulate the information device for inputting information. Besides, the touch control technology currently also becomes a popular manipulation method for the information device and brings an intuitive operation. Accordingly, a touch display device using the touch control technology can provide a friendly and intuitive interface for the input operation, and therefore users of all ages can manipulate the touch display device by fingers or a stylus.

In a common and conventional hand-held electronic device with the touch function, the touch operations are all directly executed on the display panel. However, for the operation on the middle or small size panel, fingers will shade the user's view or the functional item displayed by the display panel, such that the user may erroneously touch, by finger, an undesired one of the items which are arranged in a high information content density on the display panel.

In order to avoid the above erroneous touch situation, most methods are used to increase the size of the display panel to reduce the shade ratio so as to reduce the probability of the erroneous touch. However, such design will increase the volume of the electronic device and go against the tendency of the hand-held electronic device, i.e. lightness, thinness and compactness, and therefore it is not easily realized in the small-sized product such as the tablet computer and cell phone. Besides, the frequent touch operation on the panel of the electronic device will scratch the panel. Moreover, in the common use of the hand-held electronic device with the touch function, one hand is used to hold the electronic device while the other hand is used to operate on the display panel, so if just a single hand holds and operates the device at the same time, the touch operation just can be executed by the thumb and that is really inconvenient for the user.

Furthermore, the touch panel needs to be configured with the rare earth transparent touch sensing structure such as ITO so as to possess both of the touch and display functions, but since the rare earth metal indium is unceasingly consumed, the cost of the product is getting higher and higher. Besides, the conductivity of the rare earth metal is worse than the normal metal. Therefore, using the transparent touch sensing layer made by the rare earth metal indium is not a good choice. Moreover, with the enlarged display screen, the area of the touch sensing structure also needs to be increased, so as to increase the cost.

Therefore, aspects of this invention are to provide a shadeless touch hand-held electronic device and a touch cover whereby the finger can't shade the user's view during the operation and the scratch on the panel can be reduced and also the convenience of the single-hand operation can be enhanced.

### SUMMARY OF THE INVENTION

An aspect of the invention is to provide a shadeless touch hand-held electronic device and a touch cover wherein the touch cover is disposed on the opposite side of the panel (such as an liquid crystal display panel) to receive the input action, so that the image or object displayed by the panel can't be shaded during the user's operation, and therefore the erroneous touch can be avoided and the convenience of the single-hand operation can be provided.

Another aspect of the invention is to provide a shadeless touch hand-held electronic device and a touch cover where the touch sensing structure is just disposed in the region that allows the finger operation, so as to reduce the area of the touch sensing structure and the cost.

Therefore, a shadeless touch hand-held electronic device of this invention comprises a panel, a memory unit, a touch cover and a control unit. The touch cover comprises a cover and a touch sensing structure. The cover is disposed on the side of the hand-held electronic device opposite to the panel, at least a part of the area of the touch sensing structure is disposed on the cover, and the touch sensing structure comprises a plurality of detection points to provide an input position. The control unit is electrically connected with the touch sensing structure and the memory unit. The area of the touch sensing structure and the area of the panel have a ratio relationship, the control unit converts the input position into a display position of the panel according to the ratio relationship, and the panel displays a visible sign at the display position.

In one embodiment, the visible sign is a prompt box or a cursor.

In one embodiment, when the area of the touch sensing structure is less than that of the panel, the touch sensing structure is disposed on an upper portion of the cover.

In one embodiment, the cover further comprises a cover body and at least a sidewall, the sidewall extends from at least a part of an edge of the cover body, and the touch sensing structure is disposed on at least a part of the cover body.

In one embodiment, the touch sensing structure comprises metal mesh, metal nanowires, transparent conducting film, carbon nanotube or graphene.

In one embodiment, the touch sensing structure is a capacitive touch sensing structure.

In one embodiment, the touch sensing structure comprises a first sensing layer, a second layer and a capacitance detection unit. The first sensing layer comprises a plurality of first sensing lines disposed along a first direction. The second sensing layer is disposed opposite the first sensing layer and comprises a plurality of second sensing lines disposed along a second direction. The first sensing lines and the second sensing lines cross each other to form the detection points. The capacitance detection unit is coupled with the touch sensing structure to detect the changes of the coupling capacitances between the first sensing lines and the second sensing lines.

In one embodiment, the touch cover faces a light source or the panel's back faces the light source during the single-hand operation of a user.

In one embodiment, the hand-held electronic device is used in the single-hand operation.

In one embodiment, the hand-held electronic device is used in multi-touch operation by the single hand.

In one embodiment, a circuit board, a battery or a memory card is disposed between the touch cover and the panel.

Therefore, a touch cover of this invention is disposed on a shadeless touch hand-held electronic device which comprises a panel and a control unit, and is disposed on the side opposite to the panel. The touch cover comprises a cover and a touch sensing structure. At least a part of the area of the touch sensing structure is disposed on the cover, and the touch sensing structure comprises a plurality of detection points to provide an input position. The area of the touch sensing structure and the area of the panel have a ratio relationship, and the control unit converts the input position into a display position of the panel according to the ratio relationship.

In one embodiment, when the area of the touch sensing structure is less than that of the panel, the touch sensing structure is disposed on an upper portion of the cover.

In one embodiment, the touch sensing structure comprises a first sensing layer, a second layer and a capacitance detection unit. The first sensing layer comprises a plurality of first sensing lines disposed along a first direction. The second sensing layer is disposed opposite the first sensing layer and comprises a plurality of second sensing lines disposed along a second direction. The first sensing lines and the second sensing lines cross each other to form the detection points. The capacitance detection unit is coupled with the touch sensing structure to detect the changes of the coupling capacitances between the first sensing lines and the second sensing lines.

In one embodiment, the touch cover further comprises a cover body and at least a sidewall, the sidewall extends from at least a part of an edge of the cover body, and the touch sensing structure is disposed on at least a part of the cover body.

In one embodiment, the input position is triggered by a single hand.

In one embodiment, a part of the region of the cover is not configured with the touch sensing structure.

In one embodiment, a wiring connecting to the touch sensing structure is gathered to a single side for the wiring outlet.

In one embodiment, the width of the touch sensing structure is about 90%˜95% that of the cover.

In one embodiment, the touch sensing structure is a single-layered structure.

In one embodiment, the touch cover further comprises a near field communication unit, which comprises a near field communication chip and an antenna. The near field communication chip is electrically connected with the control unit and the antenna is disposed on the cover or the touch sensing structure.

As mentioned above, in the shadeless touch hand-held electronic device and the touch cover of the invention, the touch sensing structure is disposed on the touch cover so that the user can operate the hand-held electronic device through the touch cover. Thereby, the finger can be prevented from shading the user's view during the operation and the panel scratch problem can be reduced. Besides, by disposing the touch sensing structure only in the region which allows the finger operation, the area of the touch sensing structure can be reduced and the cost can be thus lowered down.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a shadeless touch hand-held electronic device of an embodiment of the invention;

FIG. 2 is a schematic block diagram of the shadeless touch hand-held electronic device in FIG. 1;

FIG. 3 is a schematic block diagram of the touch cover in FIG. 2;

FIG. 4A is a schematic diagram of the shadeless touch hand-held electronic device of FIG. 1 in another viewing angle;

FIG. 4B is a schematic diagram showing the scale between the touch cover and the panel in FIG. 1;

FIG. 5 is a schematic diagram of the operation of the shadeless touch hand-held electronic device in FIG. 1; and

FIG. 6 is a schematic diagram of another operation of the shadeless touch hand-held electronic device in FIG. 1.

### DETAILED DESCRIPTION OF THE INVENTION

The present invention will be apparent from the following detailed description, which proceeds with reference to the accompanying drawings, wherein the same references relate to the same elements.

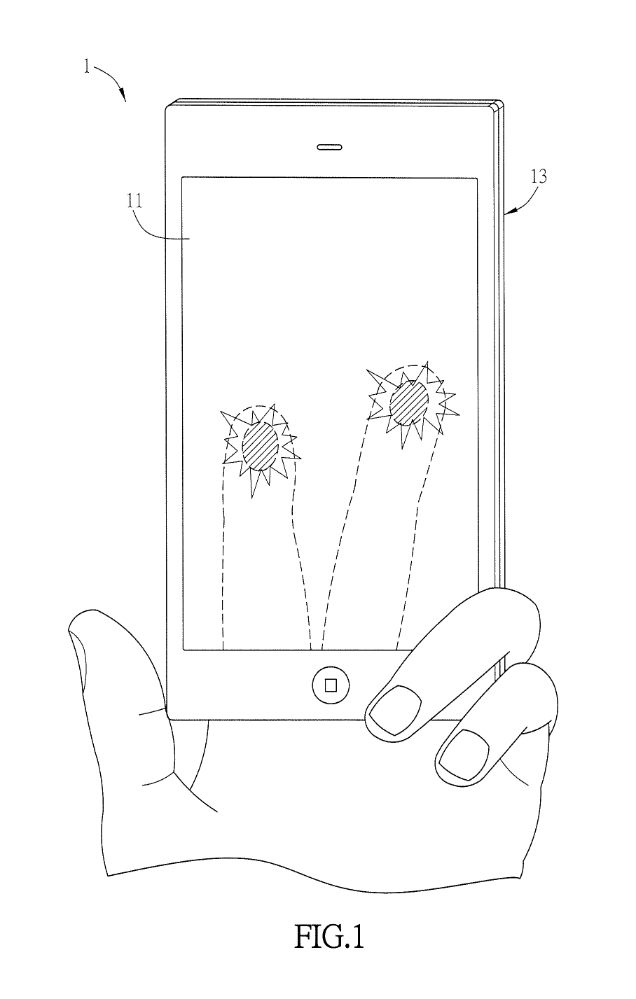

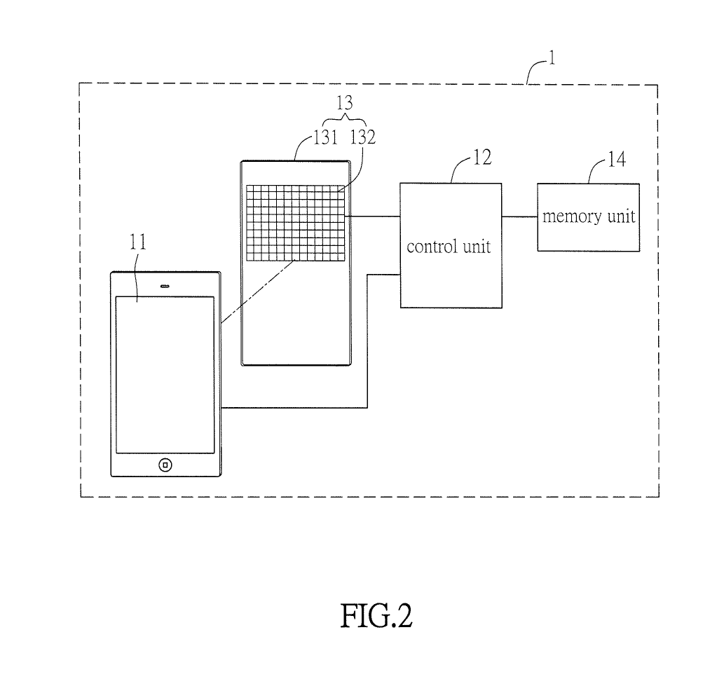

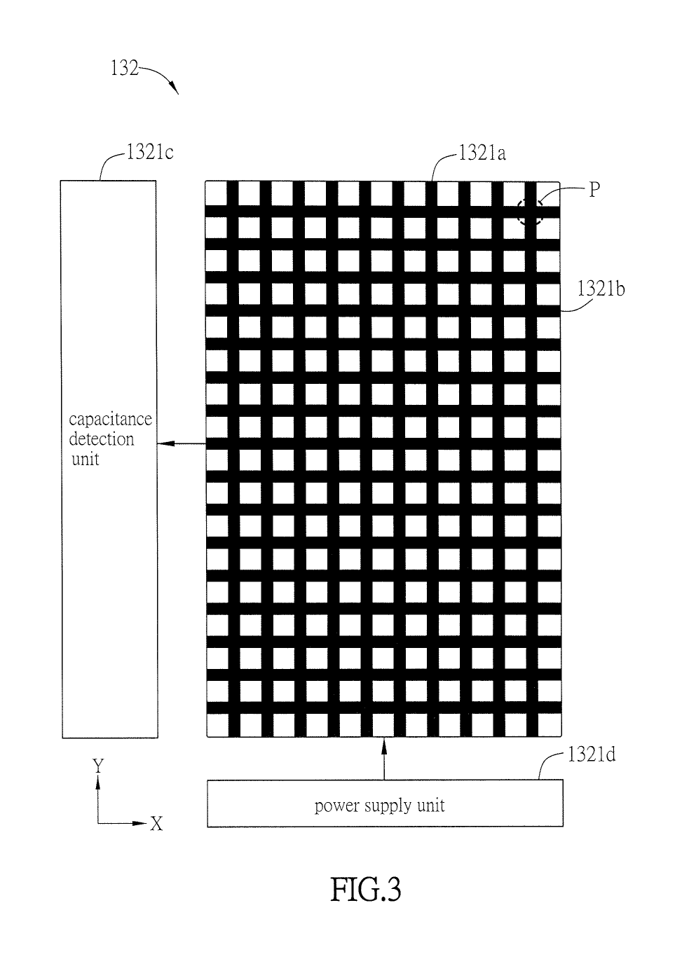

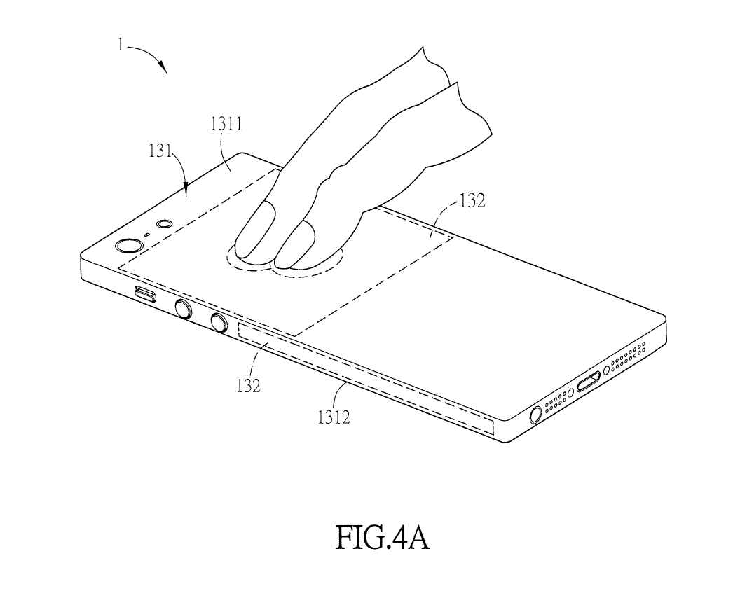

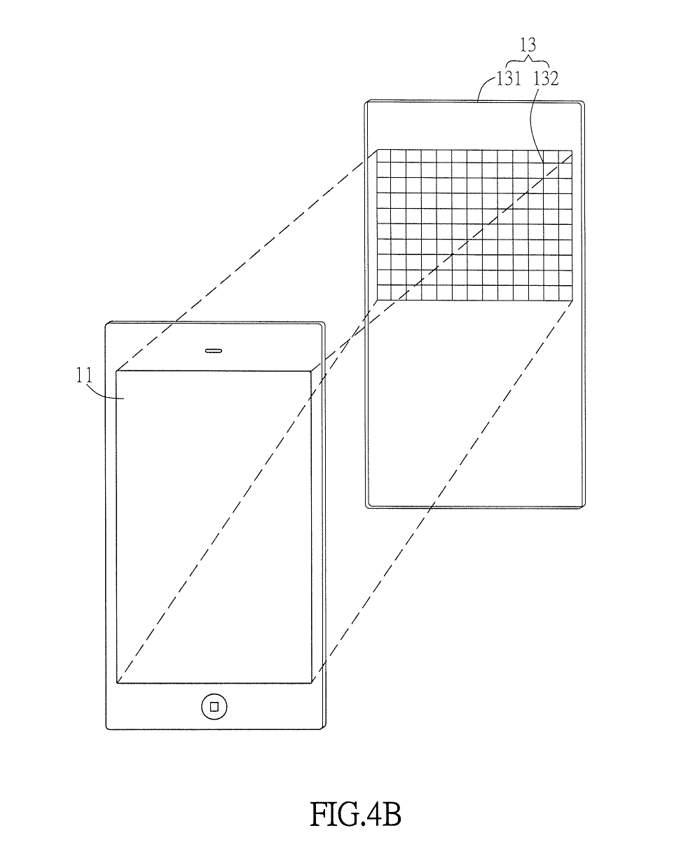

Referring to FIGS. 1 to 4B, FIG. 1 is a schematic diagram of a shadeless touch hand-held electronic device of an embodiment of the invention, FIG. 2 is a schematic block diagram of the shadeless touch hand-held electronic device in FIG. 1, FIG. 3 is a schematic block diagram of the touch cover in FIG. 2, FIG. 4A is a schematic diagram of the shadeless touch hand-held electronic device of FIG. 1 in another viewing angle, and FIG. 4B is a schematic diagram showing the scale between the touch cover and the panel in FIG. 1.

The shadeless touch hand-held electronic device 1 can be a smart phone, a tablet, a personal digital assistant (PDA), a global positioning system (GPS) device for example, and herein the smart phone is illustrated as an example. Besides, the components of the shadeless touch hand-held electronic device 1 can be made by at least a hardware, software or firmware of the signal processing and/or integrated circuit or their any combination.

The shadeless touch hand-held electronic device 1 includes a panel 11, a control unit 12, a touch cover 13 and a memory unit 14. The control unit 12 is electrically connected with the panel 11, touch cover 13 and memory unit 14.

The panel 11 is disposed on a side of the shadeless touch hand-held electronic device 1, such as the side of the shadeless touch hand-held electronic device 1 closer to the user's view. The panel 11 is, for example but not limited to, a liquid crystal display (LCD) panel, a light emitting diode (LED) display panel, an organic light emitting diode (OLED) display panel, a touch display panel or an electrophoretic display panel. The panel 11 can display electronic data, such as a graphical user interface (GUI), and the graphical user interface can include at least a figure (such as icon) displayed on the panel 11 to exhibit any kind of the known software components.

The touch cover 13 includes a cover 131 and a touch sensing structure 132. The cover 131 is disposed on the side of the shadeless touch hand-held electronic device 1 opposite to the panel 11 (i.e. the opposite side of the display surface). At least a part of the area of the touch sensing structure 132 can be disposed on the cover 131. In this embodiment, the cover 131 includes a cover body 1311 and a sidewall 1312 extended from at least a part of the edge of the cover body 1311. The touch sensing structure 132 is electrically connected with the control unit 12, and at least a part of the area of the touch sensing structure 132 is disposed on the cover body 1311. In this embodiment, in addition to being disposed on the cover body 1311, the touch sensing structure 132 also can be extended to the sidewall 1312 of the two sides of the cover 131. That is, the touch sensing structure 132 is extended from the cover body 1311 to the two sides of the cover 131, so as to increase the operation area of the user. For more effectively using the width of the cover 131 for the disposition of the touch sensing structure 132, the width of the touch sensing structure 132 can be slightly less than that of the cover 131 (such as by 5%˜10%). That is, the width of the touch sensing structure 132 is about 90%˜95% that of the cover 131. In other embodiments, the touch sensing structure 132 can be only disposed on the cover body 1311. Moreover, a physical key (such as a sound control key) can be replaced by the touch sensing structure 312, but this invention is not limited thereto. Therefore, when the user executes the operation on the touch cover 13, as shown in FIG. 1, the display of the panel 11 won't be shaded by the finger and the erroneous touch can be thus avoided.

Furthermore, the touch sensing structure 132 can be disposed on the upper portion of the cover 131, which allows the finger operation (especially for the forefinger and middle finger) when the user holds the device. Herein, the upper portion or the lower portion can be defined according to the center of the cover 131, the portion above the center is the upper portion while the portion below the center is the lower portion.

The wiring connecting to the touch sensing structure 132 can be gathered to a single side for the wiring outlet and then electrically connected with a circuit board, so as to enhance the circuit design flexibility.

Disposing the touch sensing structure 132 in the region which allows the finger operation is to reduce the area of the touch sensing structure 132 so as to reduce the cost of the hand-held electronic device 1.

Besides, other advantages of providing the touch cover 13 for the user's touch operation include that the touch cover 13 needn't be made by the transparent touch sensing material (such as ITO) for matching the display performance of the panel 11, and therefore the material selection will be more flexible and the cost can be easily controlled. Besides, the interference fringe caused by the metal wires can be avoided, so that the visibility of the display panel won't be affected and the efficiency and convenience of the manual operation can be enhanced.

Moreover, the touch sensing structure 132 also can be disposed around some places of the cover 131 where the camera lens or flash light is disposed for example.

In this embodiment, the touch sensing structure 132 is a capacitive touch sensing structure for example and formed on the inner surface of the cover 131 facing the panel 11 (i.e. the inside of the hand-held electronic device 1), or on the outer surface of the cover 131 in the opposite direction to the panel 11 (i.e. the outside of the hand-held electronic device 1), or on both of the above-mentioned inner surface and outer surface (the inside and outside of the hand-held electronic device 1). Herein for example, the touch sensing structure 132 can be directly formed on the cover body 1311 and the two sidewalls 1312. In another embodiment where the touch sensing structure 132 is disposed on the outer surface of the cover 131 against the panel 11, a protection layer is required for protecting the touch sensing structure 132. To be noted, the material of the cover 131 can be glass, plastic material, metal or other materials, and the cover 131 is a part of the whole structure of the shadeless touch hand-held electronic device 1. In other words, the touch cover 13 is not an additional component (such as the protection casing or cover of the electronic device), so if the touch cover 13 is separated from the shadeless touch hand-held electronic device 1, the inside components of the shadeless touch hand-held electronic device 1, such as battery or integrated circuit, can be seen.

Moreover, the touch sensing structure 132 can include a driving circuit and a sensing circuit (i.e. the so-called Tx and Rx, not shown), and the material thereof can be the conducting layer (such as a transparent conducting layer, including indium tin oxide (ITO), indium zinc oxide (IZO), fluorine-doped tin oxide (FTO), Al-doped ZnO, Ga-doped ZnO for example), metal nanowires, graphene or metal mesh, but this invention is not limited thereto. If the metal mesh, metal nanowires or graphene is used as the material of the touch sensing structure 132, the Tx and Rx also can be further used for the wireless power transmission (such as the wireless charging).

If the touch sensing structure 132 is made by metal mesh, the metal texture effect can be exhibited on the appearance when the touch sensing structure 132 is disposed on the outer surface (not the display surface) of the cover 131. In this case, therefore, the nonmetal cover can be used instead of a metal cover and the cost can be further saved (because the metal cover is made by a more complicated process).

As shown in FIG. 3, the touch sensing structure 132 of this embodiment includes a first sensing layer 1321a, a second sensing layer 1321b and a capacitance detection unit 1321c.

Besides, the touch sensing structure 132 can further include a power supply unit 1321d. Herein for example, the first sensing layer 1321a is directly electrically connected with the capacitance detection unit 1321c through a circuit, and the second sensing layer 1321b is directly connected with the power supply unit 1321d through a circuit.

The first sensing layer 1321a has a plurality of first sensing lines which are arranged along the first direction (the X direction). The second sensing layer 1321b is disposed opposite the first sensing layer 1321a and has a plurality of second sensing lines which are arranged along the second direction (the Y direction). Moreover, the first sensing lines and the second sensing lines cross each other to form a plurality of detection points P. The power supply unit 1321d can send voltage signals to the second sensing lines. Accordingly, because the first sensing lines and the second sensing lines are close to each other and they are all conductors, each of the overlaps (i.e. the detection points P) between the first sensing lines and the second sensing lines has a coupling capacitance.

The first sensing layer 1321a and the second sensing layer 1321b are spatially separated from each other. In physical, the first sensing layer 1321a and the second sensing layer 1321b are located on the different planes.

The capacitance detection unit 1321c is coupled with the first sensing layer 1321a and the second sensing layer 1321b to detect the input position of the user's finger on the touch sensing structure 132. Besides, in one embodiment, the first sensing layer or the second sensing layer can be used for the wireless power transmission.

In detail, when the user's finger contacts or nearly contacts a certain detection point P, the finger will change the charge coupling between the first sensing line and the second sensing line at the detection point P so as to affect the capacitance of the detection point P. By the capacitance detection unit 1321c detecting the change of the coupling capacitance between the first sensing line and the second sensing line, the contact position by the user's finger can be determined (to obtain the input position).

The capacitance detection unit 1321c can include at least one sensor IC, which is used to detect the capacitance of each detection point P, convert the analog capacitance signal into the digital capacitance signal and then transmit the digital capacitance signal to the control unit 12 (in FIG. 2, but the connection therebetween is not shown) electrically connected with the capacitance detection unit 1321c.

In other embodiments, at least a filter can be disposed between the first sensing lines and the capacitance detection unit and can be formed by an inverting amplifier circuit for example. The filter can eliminate the parasitic capacitance of the touch sensing structure, which comes from, for example, the capacitance effect between the first sensing lines, between the second sensing lines or between the sensing lines and the grounding level. In short, the filter can prevent the signal inputted to the capacitance detection unit from being affected by other capacitances except the capacitance at the detection point.

In other embodiments, for example, the touch sensing structure may be a single-layered electrode structure. For example, the touch sensing structure may include a plurality of sensing pads which are formed simultaneously, and the sensing pads may be in the form of a single-layered structure. The sensing pads may be a transparent conducting layer or a metal mesh. The shape of the sensing pad includes, for example but is not limited to, a triangle or a diamond shape, as long as they can help to achieve touch sensing operations. Moreover, all sensing pads are unnecessary to have an identical shape.

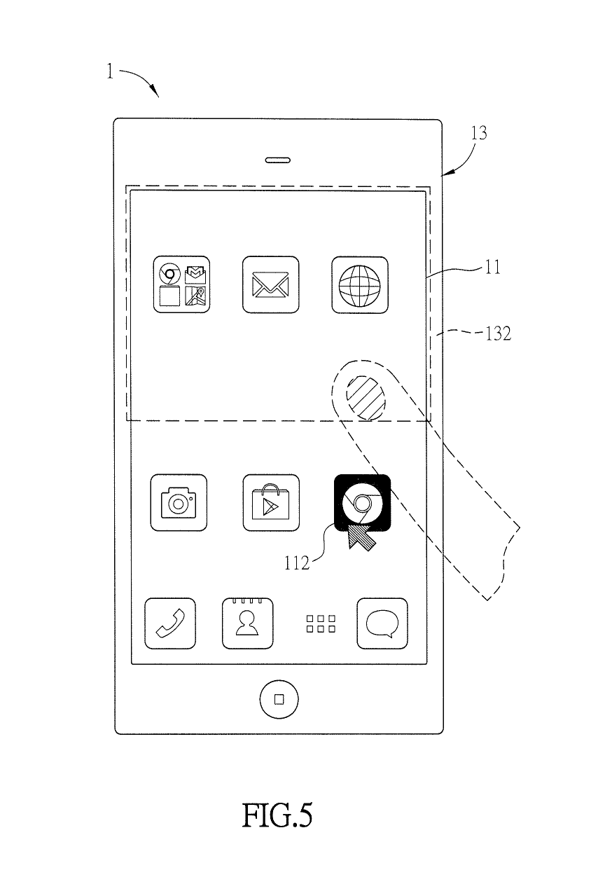

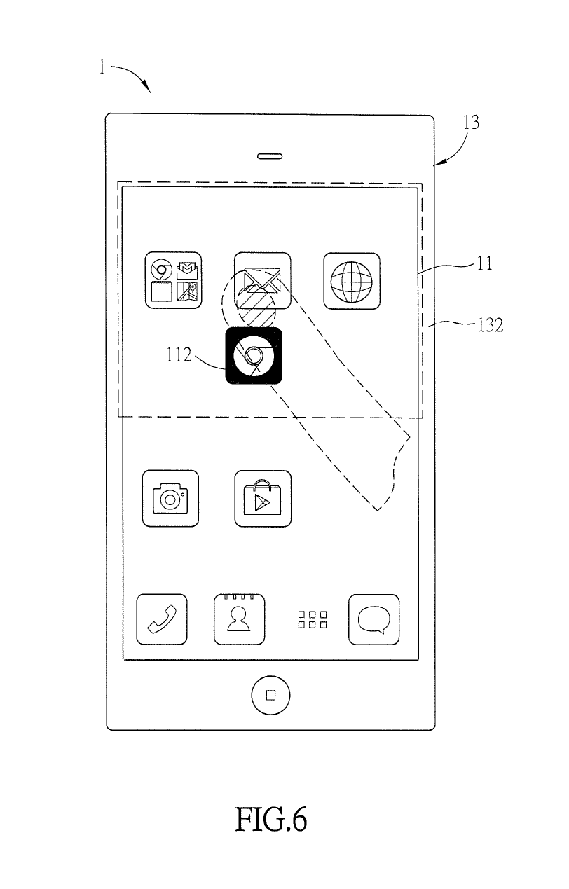

Referring to FIGS. 5 and 6, FIG. 5 is a schematic diagram of the operation of the shadeless touch hand-held electronic device in FIG. 1, and FIG. 6 is a schematic diagram of another operation of the shadeless touch hand-held electronic device in FIG. 1.

In the shadeless touch hand-held electronic device 1 of this embodiment, the panel will exhibit different graphical user interfaces according to the user's operations. In another embodiment, the graphical user interface also can be other kinds of interfaces, such as a multimedia play interface, figure, text document, table or email.

The graphical user interface displayed by the panel can include at least a figure, and the user can contact the touch cover by at least a finger or stylus to operate the figure displayed by the panel.

The area of the touch sensing structure 132 of the touch cover 13 is less than that of the panel 11 in this embodiment, and the areas have a ratio relationship (referring to FIG. 4B), which will be used by the control unit 12 to convert the touch points of the touch cover 13 into the corresponding positions of the panel 11. Although the area of the touch sensing structure 132 is less than that of the panel 11 in this embodiment, the area of the touch sensing structure 132 may be equal to (or even larger than) that of the panel 11 in another embodiment, which may occur when the touch sensing structure 132 is extended to the sidewall of the touch cover 13.

When the user executes the touch operation on the touch cover 13 by finger for example, the panel 11 can display the corresponding operation according to the user's operation gesture (or called the hand gesture), wherein the control unit 12 will convert the input position of the touch sensing structure 132 into the display position of the panel 11, and the panel 11 will display a visible object on the display position so that the user can interact with the graphical user interface displayed on the panel 11.

For example, when the user's finger slides on the touch cover 13, the panel 11 will display a corresponding icon (such as an arrow or hand shape) sliding correspondingly. Herein for example, the touch can be implemented by the user's finger or stylus contacting or nearly contacting the touch cover 13. Moreover, the interaction with the graphical user interface can be, for example, that the user touches the touch cover 13 by the finger to execute the click, enlargement or movement. For example, when the user's finger clicks on the touch cover 13, the panel 11 will drag the object 112 which corresponds to the position information. Therefore, in this embodiment, when the user directly control or execute the object displayed by the panel 11 through the touch cover 13 of the shadeless touch hand-held electronic device 1 instead of through the panel 11, the similar effect to the operation on the panel can be achieved.

However, in different environments, the same operation gesture also can start different actions, such as (1) combining the zoom and/or enlargement and rolling when the webpage size is reduced and (2) reversing (rotating) the enlargement and/or centering if the object has been centered and enlarged.

In another embodiment, in response to the multi-finger stretch gesture executed by the user on the touch cover 13, the webpage can be enlarged. Contrarily, in response to the multi-finger pinch gesture executed by the user on the touch cover 13, the webpage can be reduced in size. Moreover, in some embodiments, in response to the substantial vertical upward (or downward) sliding gesture of the user, the webpage (or other electronic data) can be rolled along a one-dimensional vertical upward (or downward) direction.

To be noted, the control unit 12 can convert the touch points of the touch cover 13 into the corresponding positions of the panel 11. Besides, the control unit 12 also can operate according to the moving velocity of the finger on the touch cover 13 and the ratio relationship, and therefore the user can execute the operation on the panel without moving the finger a lot.

Accordingly, when the user executes the operation on the touch cover 13, the user's view won't be shaded by the operation hand (so the shadeless touch effect can be achieved) and the convenience of the single-hand operation can be achieved. In comparison with the conventional art where just the thumb can be used in the single-hand operation on the panel 11, the operation on the touch cover 13 by the forefinger or middle finger can provide more flexibility and a new user experience about the single-hand holding and multi-finger touch operation.

The above-mentioned touch can include, for example, an operation gesture or hand gesture, such as a single tap or multiple taps, a single slide or multiple slides (such as a rightward, leftward, upward or downward slide), sequential clicks by multiple fingers, or simultaneous slide by multiple fingers. Besides, the operation of the shadeless touch hand-held electronic device 1 in response to the hand gesture can be determined by factory settings and/or according to the user's usage.

In one embodiment, the shadeless touch hand-held electronic device 1 can further include another touch sensing structure (not shown), which can be disposed on the panel 11 so that the panel 11 becomes a touch display panel. Therefore, the user can execute the shadeless touch operation on the cover 131, and also can use another touch sensing structure for the interaction with the device. Accordingly, the user can choose to execute the shadeless touch operation on the cover 131, or choose to operate the shadeless touch hand-held electronic device 1 directly on the touch display panel, or choose to operate the shadeless touch hand-held electronic device 1 on the cover 131 and the touch display panel at the same time.

The control unit 12 is disposed on the circuit board which is disposed inside the shadeless touch hand-held electronic device 1 and can be composed of at least a processing chip. The control unit 12 can control not only the content displayed by the panel 11 but also the operation of the touch cover 13. The memory unit 14 is a storing medium of the shadeless touch hand-held electronic device 1, and can be the memory inside the shadeless touch hand-held electronic device 1 or outside the shadeless touch hand-held electronic device 1 (such as the cloud memory or cloud storage), but this invention is not limited thereto. The memory unit 14 can include, for example, ROM (read-only memory), RAM (random access memory), flash, field-programmable gate array (FPGA) or other kinds of memory. Besides, one or more programs can be stored in the memory unit 14 and can be executed by the control unit 12 (can include one or more processors). Furthermore, the memory unit 14 also can store the operation system, application programs, data processing programs and electronic data in various formats. The operation system is the program managing the computer hardware and software resources. The application program can be a word processing program, email program or others. The data processing program of this embodiment is used to detect the data structure of the electronic data and generate the corresponding connection instruction. In this embodiment, the control unit 12 includes a central processing unit (CPU) for example to execute the programs.

In one embodiment, a circuit board, a battery or a memory card (not shown) can be disposed between the touch cover 13 and the panel 11.

In some embodiments, when the user operates the shadeless touch hand-held electronic device 1, the holding usage of the user can be preset, and the trigger event sensed by the touch sensing structure 132 is used in determining if the shadeless touch hand-held electronic device 1 can be activated to receive the subsequent input operation.

In physical, the trigger quantity distribution, trigger morphology (which can also refer to appearance), trigger time, trigger location or trigger frequency of a plurality of detection points can be computed. The control unit can analyze the trigger quantity distribution, trigger morphology, trigger time, trigger location or trigger frequency which are triggered by the user during the operation of the setting interface and define them as the activation judgment condition and stored them in the memory unit. In other words, the holding position or usage of the user operating the shadeless touch hand-held electronic device 1 can be defined as the activation judgment condition.

Therefore, when other users want to hold and operate the shadeless touch hand-held electronic device 1, the operation is forbidden because the trigger quantity distribution, trigger morphology, trigger time, trigger location or trigger frequency doesn't conform to the activation judgment condition set by the original user, and therefore the security of the shadeless touch hand-held electronic device 1 can be enhanced.

In other embodiments, the shadeless touch hand-held electronic device 1 can further include a fingerprint recognition unit (not shown), which is electrically connected with the control unit 12 and can recognize the fingerprint of at least one finger. Therefore, the user can store the fingerprint thereof in the memory unit 14 in advance, and when wanting to activate the shadeless touch hand-held electronic device 1, the user can touch, for example, a specific region of the cover body 1311 of the touch cover 13 by finger, and the control unit 12 can compare the fingerprint in the specific region with the pre-stored fingerprint. If the fingerprints match each other, the shadeless touch hand-held electronic device 1 can be activated to receive the user's input action. If the fingerprints don't match each other, the control unit 12 will judge that the user is not a permitted user so that the shadeless touch hand-held electronic device 1 can't be activated.

In other embodiments, the shadeless touch hand-held electronic device 1 can further include a palmprint recognition unit (not shown), which is electrically connected with the control unit 12 and can recognize at least a part of the palmprint of the user. Therefore, the user can store the palmprint thereof in the memory unit 14 in advance, and when wanting to activate the shadeless touch hand-held electronic device 1, the user can touch, for example, a specific region of the cover body 1311 of the touch cover 13 by palm, and the control unit 12 can compare the palmprint in the specific region with the pre-stored palmprint. If the palmprints match each other, the shadeless touch hand-held electronic device 1 can be activated to receive the user's input action. If the palmprints don't match each other, the control unit 12 will judge that the user is not a permitted user, such that the shadeless touch hand-held electronic device 1 is not activated. The above input action includes, for example, opening webpages, reading the email content, executing APPs, etc.

In one embodiment, the shadeless touch hand-held electronic device is used in the strong light environment such as the outdoor sunlight or indoor high-illuminance light. The user can operate the shadeless touch hand-held electronic device in a single hand while the touch cover faces the light source of the strong light environment (the panel faces the user) and the panel's back faces the light source of the strong light environment, so the touch cover can block the light source. Thereby, the visibility can be enhanced and the user can continue the single-hand operation. Furthermore, the user can hold the device with a single hand and also execute the input operation with the forefinger and/or middle finger, so as to enhance the single-hand operation performance of the shadeless touch hand-held electronic device under the strong light source (such as the sunlight). Besides, in comparison with the conventional art where just the thumb can be used on the panel in the single-hand operation, the operation on the touch cover by the forefinger or middle finger can provide more flexibility and a new user experience about the single-hand holding and multi-finger touch operation.

In one embodiment, the hand-held electronic device 1 can further include a near field communication unit, which includes a near field communication chip and an antenna. The near field communication chip is electrically connected with the control unit, and the antenna can be disposed on the cover or the touch sensing structure for example, but this invention is not limited thereto. When the user wants to communicate with another electronic device through the near field communication (NFC), the hand-held electronic device can be made closer to the other electronic device capable of the near field communication function to receive data from or transmit data to the another electronic device through the antenna and the near field communication chip.

Summarily, in the shadeless touch hand-held electronic device and the touch cover of the invention, the touch sensing structure is disposed on the touch cover so that the user can operate the hand-held electronic device through the touch cover. Thereby, the finger can be prevented from shading the user's view during the operation and the panel scratch problem can be reduced. Besides, by disposing the touch sensing structure only in the region which allows the finger operation, the area of the touch sensing structure can be reduced and the cost can be thus lowered down.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shadeless touch hand-held electronic device, comprising:
a panel;
a memory unit;
a touch cover comprising a cover and a touch sensing structure, wherein the cover is disposed on the side of the hand-held electronic device opposite to the panel, at least a part of the area of the touch sensing structure is disposed on the cover, and the touch sensing structure comprises a plurality of detection points to provide an input position; and
a control unit electrically connected with the touch sensing structure and the memory unit;
wherein the area of the touch sensing structure and the area of the panel have a ratio relationship, the control unit converts the input position into a display position of the panel according to the ratio relationship, and the panel displays a visible sign at the display position.

2. The shadeless touch hand-held electronic device as recited in claim 1, wherein the visible sign is a prompt box or a cursor.

3. The shadeless touch hand-held electronic device as recited in claim 1, wherein when the area of the touch sensing structure is less than that of the panel, the touch sensing structure is disposed on an upper portion of the cover.

4. The shadeless touch hand-held electronic device as recited in claim 1, wherein the cover further comprises a cover body and at least a sidewall, the sidewall extends from at least a part of an edge of the cover body, and the touch sensing structure is disposed on at least a part of the cover body.

5. The shadeless touch hand-held electronic device as recited in claim 1, wherein the touch sensing structure comprises metal mesh, metal nanowires, transparent conducting film, carbon nanotube or graphene.

6. The shadeless touch hand-held electronic device as recited in claim 1, wherein the touch sensing structure is a capacitive touch sensing structure.

7. The shadeless touch hand-held electronic device as recited in claim 6, wherein the touch sensing structure comprises:
a first sensing layer comprising a plurality of first sensing lines disposed along a first direction;
a second sensing layer disposed opposite the first sensing layer and comprising a plurality of second sensing lines disposed along a second direction, wherein the first sensing lines and the second sensing lines cross each other to form the detection points; and
a capacitance detection unit coupled with the touch sensing structure to detect the changes of the coupling capacitances between the first sensing lines and the second sensing lines.

8. The shadeless touch hand-held electronic device as recited in claim 1, wherein the touch cover faces a light source or the panel's back faces the light source during the single-hand operation of a user.

9. The shadeless touch hand-held electronic device as recited in claim 1, wherein the hand-held electronic device is used in the single-hand operation.

10. The shadeless touch hand-held electronic device as recited in claim 9, wherein the hand-held electronic device is used in multi-touch operation by the single hand.

11. The shadeless touch hand-held electronic device as recited in claim 1, wherein a circuit board, a battery or a memory card is disposed between the touch cover and the panel.

12. An touch cover disposed on a shadeless touch hand-held electronic device comprising a panel and a control unit, and disposed on the side opposite to the panel, comprising:
a cover; and
a touch sensing structure, wherein at least a part of the area of the touch sensing structure is disposed on the cover, and the touch sensing structure comprises a plurality of detection points to provide an input position;
wherein the area of the touch sensing structure and the area of the panel have a ratio relationship, and the control unit converts the input position into a display position of the panel according to the ratio relationship.

13. The touch cover as recited in claim 12, wherein when the area of the touch sensing structure is less than that of the panel, the touch sensing structure is disposed on an upper portion of the cover.

14. The touch cover as recited in claim 12, wherein the touch sensing structure comprises:
a first sensing layer comprising a plurality of first sensing lines disposed along a first direction;
a second sensing layer disposed opposite the first sensing layer and comprising a plurality of second sensing lines disposed along a second direction, wherein the first sensing lines and the second sensing lines cross each other to form the detection points; and
a capacitance detection unit coupled with the touch sensing structure to detect the changes of the coupling capacitances between the first sensing lines and the second sensing lines.

15. The touch cover as recited in claim 12, wherein the cover further comprises a cover body and at least a sidewall, the sidewall extends from at least a part of an edge of the cover body, and the touch sensing structure is disposed on at least a part of the cover body.

16. The touch cover as recited in claim 12, wherein the input position is triggered by a single hand.

17. The touch cover as recited in claim 14, wherein the first sensing layer or the second sensing layer is capable of a wireless power transmission.

18. The touch cover as recited in claim 12, wherein a wiring connecting to the touch sensing structure is gathered to a single side for the wiring outlet

19. The touch cover as recited in claim 12, wherein the width of the touch sensing structure is about 90%˜95% that of the cover.

20. The touch cover as recited in claim 12, further comprising:
a near field communication unit, which comprises a near field communication chip and an antenna, wherein the near field communication chip is electrically connected with the control unit and the antenna is disposed on the cover or the touch sensing structure.
